(19) United States
(12) Patent Application Publication
(10) Pub. No.: US 2002/0022516 A1
(43) Pub. Date: Feb. 21, 2002

(54) Advertising inside electronic games

(76) Inventor: Christopher Allen Forden, Santa Clara, CA (US)

Correspondence Address: Christopher A. Forden, 1890 Larsen Place, Santa Clara, CA, 95051, US

(21) Appl. No.: 09/906,859

(22) Filed: Jul. 16, 2001

Related U.S. Application Data
(60) Provisional application No. 60/218,720, filed on Jul. 17, 2000.
(60) Provisional application No. 60/278,462, filed on Mar. 26, 2001.

(51) Int. Cl. G06F 17/00

(52) U.S. Cl. 463/32

(57) ABSTRACT

Advertising is embedded inside video and computer games. Graphical and other game techniques are used to induce players to interact with and learn about products and advertised images. Such advertisements are distributed via various advertising venues to maximize coverage and return on development effort.

### CROSS REFERENCE TO RELATED APPLICATIONS

This application is entitled to the benefit of provisional application Ser. No. 60/218,720, filed Jul. 17, 2000.

This application is also entitled to the benefit of provisional application Ser. No. 60/278,462 filed Mar. 26, 2001.

### STATEMENT REGARDING FEDERALLY SPONSORED RESEARCH OR DEVELOPMENT

There was no federally sponsored research or development used in creating this invention.

### BACKGROUND OF THE INVENTION

1. Field of Invention

This invention pertains to a new form of advertising, specifically the practice of embedding virtual advertisements inside electronic, computer, video, network-based, or other games with changing displays.

2. Prior Art

Traditional advertising in printed media has lacked the attention grabbing quality of animation. Television advertising allows animation, and can more fully engage an interested viewer, but viewers are apt to stop paying attention to the TV when commercials come on. Often viewers even leave the room to do other things during commercial advertisements.

Both television and printed advertisements also suffer from the passivity of the viewer or reader. The viewer or reader rarely feels part of the advertisement, and is difficult to engage emotionally or intellectually.

Stores and other businesses catering to individual consumers have occasionally given away tickets with with chances to win things. Sometimes specially printed layers can be scratched off by the consumer to reveal whether s/he won a prize. Often small advertisements are printed on the tickets. However, these activities engage the consumer only briefly and do not leave most people feeling they earned anything through effort or skill.

Games command the player's attention. U.S. Pat. No. 4,067,579 to Boofer discloses a game whose board displays advertising copy related to the theme of the game, trucking. However, advertisers cannot change their advertising on the board after it is manufactured. Advertisers cannot animate or vary their advertising after players get bored of the original. The maker or seller of the game cannot limit the advertisement's time duration, and thus cannot charge a fee that varies by the amount of time the display is shown. No attempt is made to provide a general-purpose advertising venue; the game is about only a single industry, and so is the advertising.

Although the player may be emotionally and intellectually engaged in Boofer's game, s/he is experiences the advertising only peripherally and can easily ignore it. Paying attention to the advertising displayed on the board does not help the player in the game. In fact, since paying attention to the advertising would distract the player from the game's play, the player is effectively rewarded by the game for ignoring the advertising.

Many video games reward players for acquiring objects in the game. Often the desirable objects appear to hover in the air. Often they rotate or circle above other objects or elements in the virtual landscape. Rare Ltd.'s Donkey Kong for the Nintendo game console, rewards players who collect virtual bananas in the game. Its Banjo-Kazooie, also for the Nintendo game console, rewards players who collect feathers or musical notes. The feathers are attractively colored. The musical notes are shiny. Typically the collectible items appear to be three-dimensional objects, rather than mere, flat pictures of objects. Players can collect many collectible items, often many kinds of collectible items. However none of those virtual objects or their interaction with the player affects any economic value or induces any transaction outside the game except concerning the means to play the game.

Humongous Entertainment's Putt-Putt games for children allow players to acquire virtual objects. After acquisition, the objects remain displayed inside the player's car. Most games which allow players to collect objects also allow players ways of viewing their collection of objects when they wish. However, those games did not exploit the collection of items to promote products.

Many video games by many manufacturers contain hyperspace-like portals allowing a character in the game to jump instantly from one location in the game's space to another. Frequently such portals will allow a player access to a part or level of the game not easily otherwise accessible. More prosaic tunnels and passageways are also commonly used for the purpose of such special access to areas of games. However games did not use such passageways or links to entice players to approach, view, or interact with embedded advertising.

“Mother Goose's Farm 4 Learning,” a game produced by CAPS Software, Inc., created by Albathion Software Inc., and copyrighted in 1996 by Matel, was distributed on CD ROM and can be played on personal computers running Microsoft Windows(R) 95. That game uses animated twinkles surrounding virtual objects it displays. The twinkles surround objects which themselves can become animated if the player clicks on them. That game also places red flags near objects to indicate that those objects can be clicked on to enter a different game area or sub-game. However, none of those unusual items or animations is used to draw a player's interest to any advertised image.

“Mother Goose's Farm 4 Learning” was developed using software tools published by Macromedia, a company independent of the game's developers, creators, and publishers. However, none of those tools were used to advertise any product within the game, although the developer and creator of the game and tool were listed in the credits.

Charles Lutwidge Dodgson, using the pen name of Lewis Carroll, imbued various objects with fantastic characteristics in his surreal tales, Alice in Wonderland, and Through the Looking Glass. Otherwise inanimate objects became animated in his fantasy worlds, and would even engage the protagonist in conversation. The protagonist shrunk and then interacted with objects which appeared, relative to her, to be much larger than in real life. Dodgson succeeded in capturing many a reader's imagination. However he did not even attempt to exploit the readers' interest to affect the reader's purchase of goods or services, other than the books themselves.

Dodgson's tales have often been made into movies in which the viewer views a surreal world from Alice's point of view, identifies with Alice's character, and experiences the fantasy world from her size and perspective. Walt Disney has made films, notably Fantasia, in which normally inanimate objects become animate and interact with characters in the film. A broom, for example, becomes alive, sprouts arms, and carries buckets of water. Mickey Mouse, a well-known celebrity, interacted with the broom stick and water in that movie, in a cartoon segment played to the music, The Sorcerer's Apprentice. However, none of the creators even attempted to use those artistic works to exert substantial influence over consumption of things other than the films themselves.

In many games (for example the previously cited Putt-Putt) and in many cartoons, cars and other machines converse with other characters. However, none of the speech of normally non-speaking objects in games has been directed toward motivating the player to buy anything, as television commercials long have.

Chevron has run commercials on television in which cute, talking cars discuss the merits of Chevron's gasoline. Although the cars and their animation are fetching, and their discussion promotes a product, the viewer cannot affect the cars' behavior or otherwise actively interact with them. Consequently the viewer tends to lose interest quickly and is not fully engaged emotionally or intellectually by those commercials.

It is common for video and other electronic games to pose questions to players and reward correct answers by granting special powers to the player's characters, or access to special portions of the games' virtual territories. Humongous Entertainment's Pajama Sam series of computer games for children uses this technique. Rewarding correct answers to questions that challenge the player's knowledge is especially useful and consequently frequently employed for educational games.

Rare Ltd. embeds virtual advertising for some of its games inside other of its games. The advertisements in the virtual world of the game resemble traditional advertising outside games; the advertisements take the form of passive billboards. Players are not rewarded for interacting with those advertisements. Virtual billboards inside electronic games sometimes carry product images. However, those product images are only two-dimensional pictures. If a player moved to view the billboard from a different angle, the product's image would merely compress along the dimension of motion; The flat image would not reveal three-dimensional shapes of parts or hidden features, as a player viewed it from different angles. Therefore previous virtual advertisements share the disadvantages of the real-world advertising they mimic.

Video games of racing have sometimes depicted likenesses of real cars or cycles which players interact with by driving around a virtual race course. The publishers or developers of such games might have even received payment (sponsorship) from the makers of those vehicles. Such games might even have advertised other racing-related products such as helmets. However such racing games have never offered a general-purpose advertising venue and have never advertised products not used in driving and racing activities.

Internet advertising is easily varied over time. Many internet sites provide general-purpose advertising venues. Internet users pay attention to the screens on which the advertisements are displayed. If a viewer leaves the room, the advertisement can remain displayed until s/he returns and actively engages the computer again. Alternatively, internet advertisement brokers can schedule web-page ads to change quickly, for example second-by-second. Such quickly changing advertisements can catch viewers eyes. However, techniques of flashing advertisements can annoy users who inevitably view them as distractions because the advertisements are not what viewers have visited the web page to focus on.

Internet advertisement brokers can also change advertisements slowly, for example month-by-month, as old sponsors fail to renew contracts and new sponsors are found. However, it is still easy to ignore banner and other typical internet advertisements.

Various internet sites allowed anyone to play games for free. The web sites earned money from the games by posting traditional advertising banners on the same web page. Yahoo.com had a games site. Another site that offered free games prior to the filing of my provisional patent is http://www.gamesville.lycos.com/.

However, the advertising of these sites was at best adjacent to the games, not embedded in them. Players naturally tended to ignore the advertising even without trying. Since that kind of advertising is merely a distraction and can interfere with a player's chances of winning, players would be motivated to try to ignore the advertising.

The free internet game sites prior to 2001 were forced to offer games that were much less interesting (in both plot and visual effects) than games sold. Because the prospects for earning advertising revenue from traditional advertisements around the game were meager, little money could be invested in game development and support.

Software tools including Application Programming Interfaces (APIs), software frameworks, and Software Development Kits (SDKs) have been developed and commercially distributed. Typically they facilitate the use of an underlying platform. That platform could be computer hardware, or another underlying layer of software such as an operating system. Such software tools have even been developed to facilitate game development.

Specialized game features such as physics calculations have been facilitated by such tools. Typically such tools would include some software modules that get linked with the main game software module and which execute during the running of the game. Game-physics modules calculate such effects as the motions of objects resulting from forces applied to them.

However no such tools have been offered for embedding advertising inside games. No such tools have been created for facilitating the widespread distribution of a given embedded advertisement into many games, each of which may have been developed with software tools incompatible with those of other games.

### BACKGROUND—ART PUBLISHED AFTER MY PROVISIONAL PATENT

A Wall Street Journal on Apr. 30, 2001 described on p. B1, a web game created to promote the movie “AI”. Although the article said that a clue to the game's mystery could be obtained using software (Microsoft(R) Paint(™)) from a firm different from the movie's producers, the article said the use of that software was too obscure. That software is given away free with the maker's operating system, and is not strategically important, so the software maker benefits little economically from that clue. Also, there are many other software applications from other software vendors (e.g. Adobe(™) Photoshop(™)) which could alternatively be used to magnify the image in the game, thereby helping the player find the clue just as well as Microsoft Paint could.

The article described effects coordinated with a communicative media besides just the internet. Players received automated phone messages through their real-life telephones, apparently from fictitious characters in the game. The article described the incorporation of several different web sites in the game and described how players would not necessarily know whether characters in the game were real people or software agents, or on whose side several characters were playing.

A news story published on the internet by CNET (http://news.com) on Jun. 1, 2001, “Films drive Web surfers to BMW site”, states “Offline companies are increasingly using entertainment and games to promote their products online. Nike, Burger King, General Motors, ESPN, Pepsi, Nickelodeon and Paramount are among those lining up to create online games featuring their wares.”

Another CNET story, “Major brands play for attention” dated May 3, 2001, introduced the word “advergaming” to describe advertising in games. It listed companies beginning the practice and described some advantages: “‘Interactivity is a big hook,’ said Van Baker, vice president in e-market intelligence at research firm Gartner. ‘Anything that is engaging for the consumer will make the ad more appealing by definition.’” The article mentioned a company, Yaya (http://www.yaya.com) of Los Angeles, Calif., that offers to develop a game for a sponsor in which that individual sponsor can advertise its products.

### SUMMARY

In accordance with the present invention, a practice of advertising products inside electronic games induces consumers to interact with recognizable representations of products, services, or corporate property of various advertisers.

### Objects and Advantages

Accordingly, several objects and advantages of the present invention are:

(a) to use electronic games as advertising venues in which sponsors can advertise their products and services effectively by fully engaging viewers and maintaining their interest;

(b) to facilitate the placement of advertisements in more than one game, so that a larger audience can be reached;

(c) to represent products or stores in a game in ways that are enhanced, memorable, positive, or attractive;

(d) to associate products, services, or companies, as viewed in games, with lifestyles or celebrities which will enhance the perceived desirability of the advertised products or services.

(e) to control the placement, lifetime, or distribution of advertising in games so that economic remuneration to an advertising agency can be enhanced, or flexibility of fees can be offered to an advertising customer.

(f) to distribute game code or physical media in ways which induce consumers to visit an advertiser's physical stores or places of business, or to view its advertising or information via some distribution channel associated with the game;

(g) to provide advertising brokerage services by optimizing and placing advertising inside electronic games;

(h) to facilitate product sales inside electronic games, in convenient conjunction with advertising there.

### DRAWING FIGURES

FIG. 1 shows an example of a game's character interacting with a enlarged likeness of an advertised product, and approaching reduced-scale, collectible likenesses of advertised products.

FIG. 2 shows representations of a portal to another area of game play, a celebrity approaching an advertised product, a sponsor's place of business, and a means of transacting sales inside a game.

FIG. 3 diagrams the information flow of the placement of advertisements in various venues, for two unrelated products.

FIG. 4 diagrams the information flow during operation of embedded game features distributed as an advertising module to an independent game developer.

FIG. 5A shows communication software being used with a game.

FIG. 5B shows the communication software being used after acquisition motivated by the game, but no longer with the game.

FIG. 6 shows a billboard in a game, with which players can demonstrate their knowledge of a product.

### REFERENCE NUMERALS IN DRAWINGS

10 girl

11 hamburger

12 bicycle

13 bicycle

20 portal icon

22 bicycle

24 Uncle Sam

26 bicycle store window

28 credit card icon

30 Fast Food advertisement

32 bicycle advertisement

34 Fast-food game

35 Fast-food game, second published version

36 Fast-food game, third published version

38 Newspaper

400 Player

402 Electronic game hardware

404 Keyboard input device

406 Joystick input device

410 Graphic display output device

412 Speaker sound output device

414 RAM—Random Access Memory

416 CPU—Central Processor Unit

418 ROM—Read Only Memory

420 Graphics acceleration circuitry

430 Firmware (software in ROM)

440 Generic game-animation software

442 Generic game software's API

450 Unique game content

460 Landscape database

462 Character database

464 Plot sequence database

466 Collectible items database

468 Collected items list

470 Software advertising module

472 Landscape database

474 Character database

476 Collectible items database

478 Advertised products database

480 Information flow in callbacks to ad module

482 Information flow in callbacks to ad product database

500 Electronic game

502 Central host computer

504 Communication program named “quickEmail”

506 Game character simulated by host computer

510 Friend of player

514 Second copy of quickEmail communication program

520 Central mail server

600 Virtual billboard inside electronic game

602 Prompt about advertised product

604 Buttons to signify possible responses to prompt

606 Correct answer to prompt

608 Incorrect answers to prompt

### DESCRIPTION

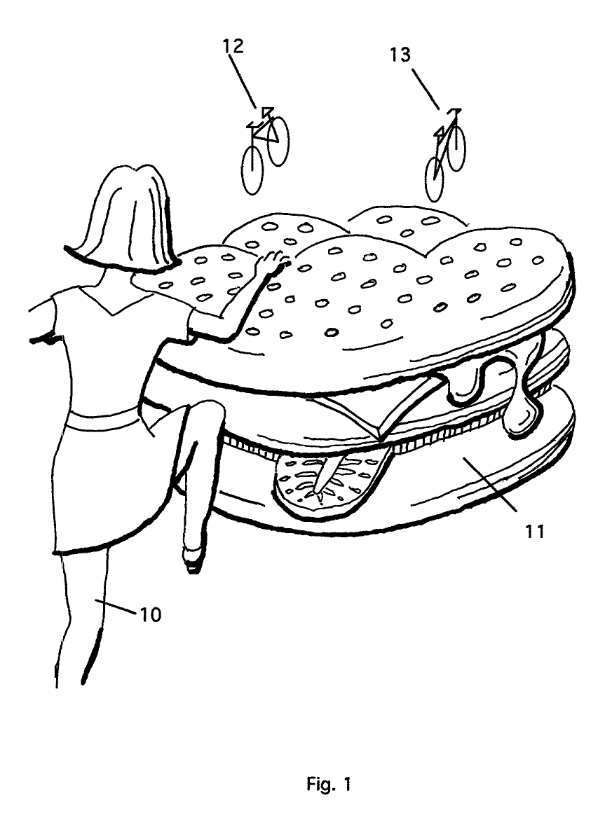

### FIG. 1—Preferred Embodiment

A preferred embodiment of the advertising method is illustrated in FIG. 1. FIG. 1 shows an example of a video image displayed to a person playing an electronic, video, or computer game. Girl 10 is controlled by the game player. Therefore the player typically sees and interacts with virtual objects in the game as girl 10 does. Consequently the player identifies with the character of girl 10.

In FIG. 1, girl 10 is climbing onto a hamburger 11 like one sold at a fast food restaurant. However in the displayed image, hamburger 11 is as large as girl 10. The person playing the game will therefore perceive hamburger 11 as fantastically large. That unusual scale will help to burnish the image of hamburger 11 in the player's memory as well as draw his attention to it while he plays the game.

Not shown in FIG. 1 are other characteristics which electronic games could apply to hamburger 11 which cannot be shown in unanimated line-drawings. Hamburger 11 will compress as girl 10 steps or pushes on it. That action will be accompanied by squishing and slurping sounds. When properly implemented, the sensory impressions the game provides will make the person playing the game think about the various sensations he experiences when eating a hamburger. Thus the player is induced to visit a fast-food restaurant, one chain of which would have paid to place advertising in the electronic game depicted.

Hamburger 11, an advertised product, appears larger-than-life to the game player, thus is more conspicuous and tempting. Above Hamburger 11, circle two bicycles, 12 and 13, products sold by a different company. Thus the advertising broker for the game depicted, has sold advertising space and features to both a bicycle vendor and a fast-food restaurant.

Bicycles 12 and 13 appear smaller-than-life to the player. Their reduced scale allows them to appear in many different scenes in the game without crowding out other visual game elements. In FIG. 1, bicycles 12 and 13 are collectible items. When a player collects them (typically by doing little more than touching them in the virtual space of the game), the player is rewarded by winning points in the game.

In FIG. 1, bicycles 12 and 13 change colors every second. Every element of the bicycles' frames glows. Note that in real life, bicycles can neither change colors every second nor glow. Hence the advertisement draws the player's interest by its unusual animation and rendering of the advertised product. The bicycles' hovering in the air, and circling without riders, also constitute fantastic animation and rendering and also helps to draw the player' attention.

FIG. 1 shows girl 10 climbing onto hamburger 11. The game player (not shown, outside the realm of the figure) will manipulate his controls so that his controlled character, girl 10, climbs onto hamburger 11 in order to collect bicycles 12 and 13. The desirability of interacting with one product, hamburger 11, thereby has been enhanced by attributes of another product, bicycles, represented in the game by icons of bicycles 12 and 13. The collectible icons that induce the player to interact with one advertised product need not be icons of another product. However there can be benefit to the advertiser by unconsciously associating its product with a particular lifestyle or demographic group by frequently choosing appropriate collectible or otherwise desirable images with images of the advertiser's product.

When a player has won a sufficient number of points, the player is awarded a voucher for a menu item at a fast-food restaurant in the real world. Claiming the prize will necessitate a trip to the restaurant. Since the player is likely to be younger than driving age, one or more family members are likely to accompany the player to the restaurant. They are then likely to each order additional menu items. Those additional orders provide part of the economic incentive for the restaurant to participate in the program.

When the player orders additional menu items at the restaurant, s/he becomes eligible to receive a free disk with additional game features, playable territory, and levels. Thus the restaurant serves as a physical distribution point for the game. People who might not otherwise know about the game, encounter it and promotions for it at the restaurant. The restaurant benefits from physically distributing the game by receiving additional customers. The advertising company benefits by having more people play the game, thereby making it more attractive to advertisers not associated with the restaurant. The embedded advertising might pay for all development and distribution costs.

It is easy to understand, while looking at FIG. 1, that if you owned a restaurant selling hamburgers, that you would be willing to give away such game cartridges or disks. Not only would that bring people into your restaurant to get the games, but the voluptuous images of food would also bring them back by making them think of your menu items.

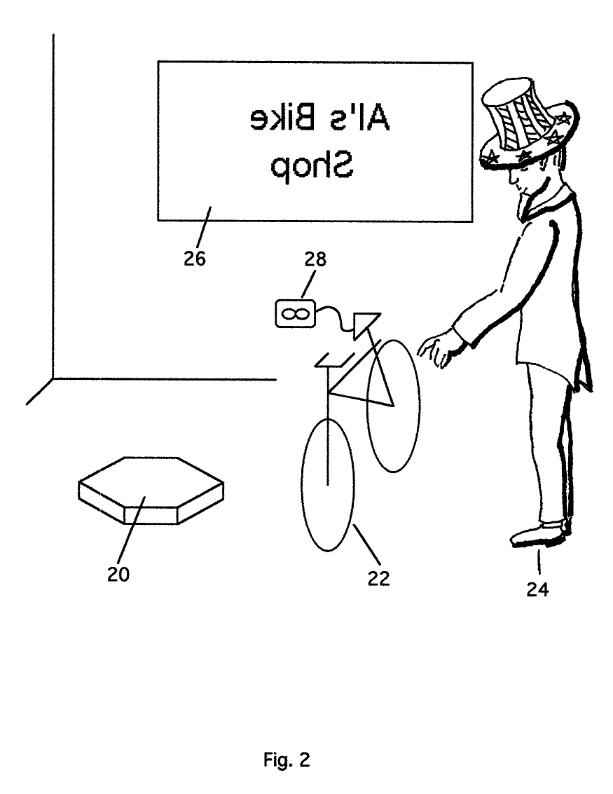

### FIG. 2—An Alternative Embodiment

FIG. 2 is a scene of the inside of a bicycle store as seen by the player of an electronic game. Window 26 displays “Al's Bike Shop” from the reverse side of the glass, showing to the player that his point of view is from the inside of the store.

Celebrities inside games could endorse or otherwise advertise. Celebrities could include real living or historical people or fictitious characters from games, cartoons, movies, songs, stories, novels, or other fiction. The mere presence of a celebrity's likeness could induce a player to enter an area with advertising. By having celebrities interact with players, their value could be made much greater. Players would spend more time viewing advertised images and thinking about the associated products. Some of the celebrity's glamor or other appeal would remain associated with the sponsored product.

Uncle Sam 24, a well known celebrity, approaches bicycle 22. His presence beside, movement toward, and interest in bicycle 22, directs the player to bicycle 22. Uncle Sam 24's outstretched finger, pointing toward bicycle 22, also directs the player toward bicycle 22. As he approaches bicycle 22, Uncle Sam 24, says “This bicycle saves energy. I want more Americans to use these.” Since bicycle riding is a social good as compared to driving vehicles that consume large quantities of gasoline, game features like these could be a public service message. A similar display could alternatively be used to advertise a particular brand of bicycle, and/or a particular chain of bicycle stores.

Portal 22 is a desirable feature that players find in the store. By positioning her character on the hexagonal pedestal that indicates the portal, a player jumps to a higher level in the game. Such passage might be the only admission to some level or area of game-play. Suspecting the presence of such portals in advertised stores will draw players to the stores where they will see products and other advertised images. A portal for this purpose could alternatively appear to as a traditional passageway such as a tunnel, gateway, or conveyance. In FIG. 2 the portal is represented as an abstract, geometric shape because the transport takes place and concludes instantly upon climbing it. That appearance thereby emphasizes the hyperlink-nature of the portal in the game in FIG. 2.

Portal 22 is displayed close to bicycle 22. By seeking such portals, players can be drawn near advertised images such as bicycle 22. Any other kind of reward could be used to draw a player, her character, or her attention to or near an advertised image.

Credit card icon 28 is attached to bicycle 22. By clicking on or otherwise indicating credit-card icon 28, the player can immediately bring up a window allowing her to purchase the advertised bicycle.

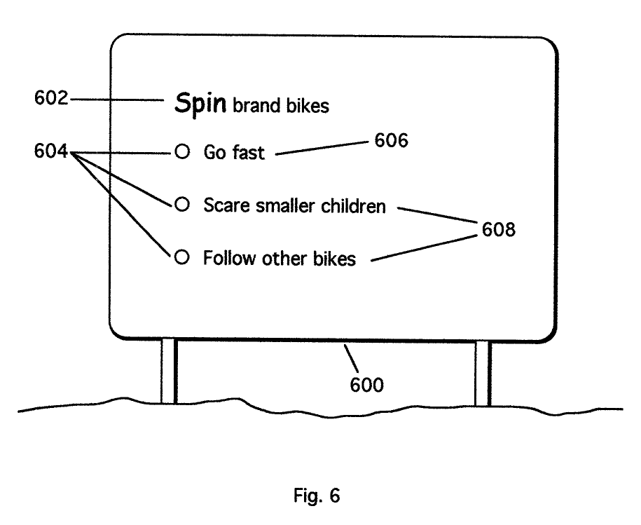

### FIG. 6—Alternative Embodiment for Product Knowledge

Players could be given rewards for demonstrating knowledge about an advertised product, or about the sponsor. Explicit quiz questions could be given the players, or more subtle use of knowledge of the product could be used. Players could indicate their knowledge of the features of an advertised product by entering corresponding parts of the game or interacting with game features in a way that those who understood a feature of the product would choose to do.

FIG. 6 shows a billboard 600 which can be visible at some point to players playing an electronic game. Prompt 602 suggests that players respond by demonstrating their knowledge of the bicycle product. Buttons 604 allow the player to choose a response to the prompt. Answer 606 is correct; if players push its button, they will receive some reward. Answers 608 are incorrect and will not be rewarded.

Rewards can include points, collectible icons or other visible items, anything that determines success in the game, anything that facilitates success in the game, including clues to playing the game, ammunition, energy, playing time, abilities, weapons, shields, or other useful devices in the game. Rewards can include admission into special areas of the game. Rewards inside a game can also include things valuable outside the game such as coupons (paper or electronic) for purchasing real-life products, admission into some special area, real or virtual, and rights to play other games.

### The Player's Subjective Experience

In the virtual landscape of a game, the player will encounter, vicariously through the character in the game that he controls, other objects in the virtual landscape. For linguistic simplicity, I describe the player as experiencing those things his character experiences in the game. This linguistic shorthand is appropriate because the experience the player has of the game and its contents is determined by the virtual experiences of the player's character in the game. Thus when Alice was small in Wonderland, the objects she encountered were effectively enlarged.

I have not provided drawings for all additional embodiments because the spatial configurations are limited only by the imaginations of the designers and programmers of the game. A drawing would represent only one kind of product advertised, whereas this invention describes advertising techniques useful for almost any product, service, or corporate public relations need. Drawings are useful for showing how a designer can accommodate natural or physical laws in a design. However, the virtual space in which a player moves is not bound by the laws of physics of any real world. Words convey the range of possibilities of cyberspace images and interactions better than drawings.

Some of the things the player encounters as he moves throughout a game's landscape, can be depictions of the advertiser's stores, restaurants, or other real places of business. In virtual stores, he might find virtual objects or effects that can help him play the game successfully. Therefore he will be motivated to enter and examine the advertiser's virtual store or restaurant.

This principle can be obviously extended to other kinds of places of business which sell, provide, or rent other things. For example if the product being advertised were an article of clothing instead of a food item, the player could be induced to visit a virtual clothing store.

Some of the inducements to visit the virtual stores or restaurants could include the following things, inside or associated with the virtual store:

(a) portals or passageways to other levels or areas of the game;

(b) collectible objects or icons or tokens;

(c) hints or clues about how to win the game;

(d) visual enhancements such as prettier colors, or more graphical detail;

(e) direct rewards in game-points or other scored items.

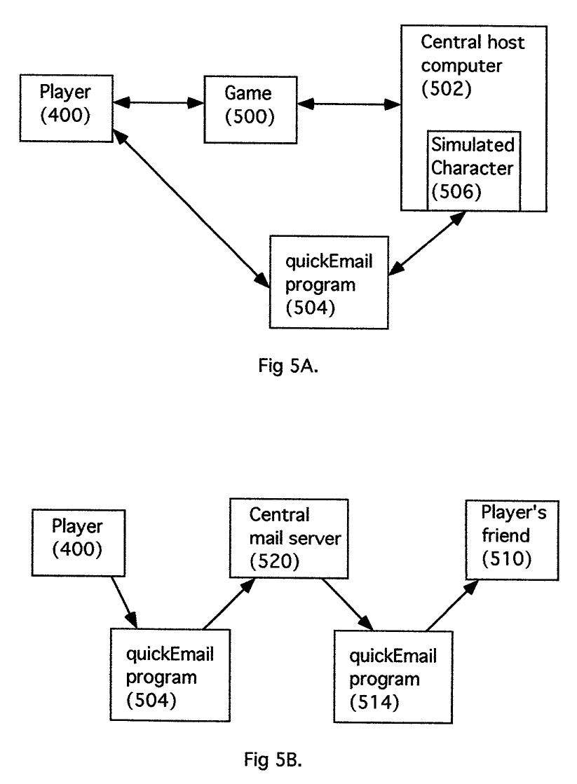

### Additional Embodiment—FIGS. 5A AND 5B

A software maker could advertise its important software in a game by making it required or helpful to succeed in the game. Strategically important software could be required to use in order for players to win or accomplish goals in the game. For example, AOL Instant Messenger could be required to receive messages from characters in the game or other clues. AOL and Microsoft are vying to spread their competing communication software and get more people using their own communication software than that of their rivals. By requiring some particular software to be used in order to accomplish something in a game, software and communication companies could increase their market share. Such increased market share is acknowledged to be a key competitive goal for many software and communications firms.

FIG. 5A shows information flow during, and in conjunction with, playing an electronic game which is partially controlled by a remote host computer on the internet. The bidirectional arrows indicate that information flows both ways along the connections.

Player 400 interacts with game 500 whose implementation software interacts with central host computer 502. During the course of the game the player is told of the existence of a character which exists as simulation 506. The player is told that he needs to communicate with simulated character 506. (Of course he is not told that character 506 is a simulation.) He is also told that the only way to communicate with character 506 is via a special software program, hypothetical, named “quickEmail” for this discussion, and designated 504 in the figs. In order to communicate with character 506, Player 400 must acquire quickEmail 504.

After using quickEmail 504 to communicate with game character 506, Player 400 can continue using quickEmail 504 to communicate with his friends and others. FIG. 5B shows quickEmail 504 in its normal mode of operation. A user, Player 400, sends an email using the program. The email goes through his copy of quickEmail 504, to a central mail server 520. The central mail server 520 holds the email until the moment the player's friend 510 connects to the internet. At that time, friend 510's copy of quickEmail 514 retrieves the email from the central mail server 520. It then displays it to friend 510. The arrows indicate the direction of travel of the email.

Since quickEmail 504 is used at both ends of the communication, it can lock out mail servers it wishes to exclude from participating. That exclusivity would be undesirable from the point of view of player 400 and friend 510. The need to use quickEmail 504 in game 500 may overcome their dislike of quickEmail 504's exclusivity.

### Enhancing Economic Feasibility of Embedded Advertising

Games could be provided easily for free over the internet, either on web sites or as downloadable code. Downloadable code can be played on computers with no additional hardware modifications. Future dedicated game consoles can be designed to run freely downloadable instructions for game computer processors instead of, or in addition to physical cartridges or disks which they now require.

Electronic games played over the internet, or downloaded remotely, can easily be modified after their original publication. New, modified versions can have new advertisements embedded inside them. A new version of a previously published game, can have a previously embedded advertisement deleted. Deleting old advertisements allows advertising brokers to charge fees dependent on the amount of time or viewership the advertisement receives. A similar advantage of modifiability applies to games distributed at subsidy frequently or continuously inside places of business, or by subscription to players.

An important factor in the success of such practice would be the careful embedding of the advertisements in the games. If they are interesting and enticing to consumers and players, then the free distribution of games will be economically viable. Similarly, the wide distribution of advertisements for a given product in many different games and other advertising venues, will make the development of attractive embedded advertisements more cost-effective.

An advertising broker could place advertisements for a sponsoring client, in a wide range of media including various venues consisting of various electronic games; and also more traditional advertising venues such as radio, newspaper, television, and banners on web pages. The placement of advertisements in traditional advertising venues will help defray the costs of the innovative advergaming broker, and help to establish advergaming by attracting clients which would be leery of placing its advertisements only in games. Game characters and other features could be developed which would be most attractive and effective, and interactive only inside games, but which can also appear in traditional advertising media, thereby further extending the psychological impact on consumers of the advergaming features.

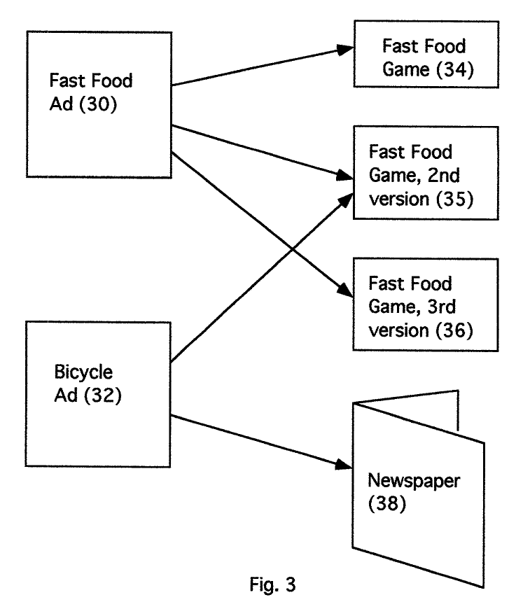

### FIG. 3—Wide Distribution, an Additional Embodiment

FIG. 3 shows the flow of advertisements of different products to various venues during advertising placement by a single advertising broker. Fast-food advertisement 30, which could include hamburger 11, originally is published in fast-food game 34. Fast-food game 34 is distributed in some chain of fast-food restaurants. After a period of two months, the distribution of the original version of the fast-food game 34 is withdrawn from distribution. The game developer, which either is an advertising broker or works with an advertising broker, creates a new version of the fast-food game. The new version contains additional landscape, characters, story, and challenges. Those added game features will entice players, now bored of the original fast-food game 34, to want to play fast-food game, second version 35.

The success of original fast-food game 34 has induced a bicycle manufacturer to place and pay for an advertisement in the game. Therefore the developers of fast-food game, second version 35 also embed bicycle advertisement 32 in it. Bicycle advertisement 32 can include collectible images of bicycles 12 and 13, and could be closely interwoven with fast-food advertisements, as FIG. 1 depicts. Fast-food game, second version 35 is then distributed in place of fast-food game 34. The bicycle manufacturer pays the advertising broker for the ad (advertisement) placement. Additional consumers buy that brand of bicycles after learning to like them by playing the game.

However, the bicycle manufacturer has paid only for two months worth of advertising. Perhaps the manufacturer only wanted to try this new kind of advertising and evaluate its effectiveness. Perhaps it quickly saturates the additional market it reaches. In any case, the manufacturer declines to buy additional advertising time inside the fast-food game. Therefore the developers of fast-food game, second version 35 then create fast-food game, third version 36. This new version contains more new game features, but omits bicycle advertisement 32.

Thus the technique of republishing the same game in differing versions has bestowed an important characteristic to ads embedded in games that traditional advertising has long enjoyed—the ability to limit advertising by duration, and therefore to charge according to the amount of time an advertisement runs. A key to the ability to do this is the distribution method of the games. Games repetitively distributed will be easy to use with this technique. The use of this technique will benefit store owners in which the games are distributed. This technique will help pay for additional, new versions of games, which in turn will repeatedly attract consumers to the stores in which the games are distributed. Thus this technique of adding or removing ads has synergy with the preferred embodiment discussed earlier in which advertising games are distributed in ways which attract potential customers to physical points of sale such as stores, restaurants or other places of business.

Games supplied or played via a network will also be ideal venues for adding new ads or limiting the duration of existing ads. Such network-based games can also be used to attract customers to network-based, virtual places of business such as corporate web sites and other electronically disseminated depots of information dominated by that sponsor. Such sites have frequently presented network-based, convenient facilities or purchase goods or services, albeit outside games. Since web-site visitors have already become accustomed to purchases via web sites, this technique of controlling the duration of ads would combine effectively with the previously discussed technique of embedding inside games, facilities to transact purchases.

The bicycle manufacturer on whose behalf bicycle ad 32 was created, would understandably be less interested in paying continuously to advertise in the fast-food game than would fast-food vendors. While bicycle-related activities are not incompatible with activities related to fast-food, neither are they inherently related to fast-food in the real world. The bicycle advertiser maximizes advertising value by sporadically advertising in unrelated games such as fast-food game 35 and also advertising elsewhere.

FIG. 3 shows that the advertising broker has therefore also placed bicycle ad 32 in another venue, as well, newspaper 38. Bicycle ad 32 would need extensive adaptation for a non-interactive advertising venue such as a newspaper. However by retaining memorable static images and characters, bicycle ad 32 could still be recognizable there. Such advertisements, placed in disparate media, can serve to reinforce the common imagery and themes displayed by the advertisements, and to make them seem less dedicated to virtual spaces such as web sites and electronic games.

Of course, alternatively, advertising brokers could place dissimilar ads for the same product in dissimilar media. Such dissimilar ads might share no common image, character, or theme. Such activities would still constitute normal advertising brokerage services on behalf of a client. In particular, an advertising broker specializing in advertising inside electronic games could contract an advertising agency that frequently places ads in traditional media, to create as well as place ads there. Such activities on behalf of a client would also constitute the technique of placing advertisements for a sponsor in different venues.

### Distributing Content to Independent Game Producers

A virtual advertising broker could offer to give away free or at subsidy, virtual landscapes, characters, behaviors, and other component features of games, to independent developers of games. The subsidized game-content components would contain virtual advertising embedded in them. For example, large, interesting virtual landscapes could be created containing many interesting plants, trees, animals, buildings, roads, bodies of water, atmospheric phenomena, sub-games, and other features. Banner or billboard, and/or interactive advertisements could be embedded on or inside many of the more interesting features. Independent game developers could take this content and add it into their games and sell or otherwise distribute the completed games. Players would be able to play the games, and as they desired, to play on and otherwise explore the virtual landscape the advertising broker created. Thus they would come into contact with advertisements the broker embedded in its part of the virtual landscape.

Although in the landscape distributed to other, independent game developers, the advertiser might not be able to make the interaction with its products requisite to winning the game, the advertiser could provide other inducements. For example the advertiser could embed URLs, virtual coupons which could really be redeemed outside the game, hints, clues, trivia, interesting background or back-story for other games, and associate such rewards with the advertisements embedded and distributed to other game developers. For example, the advertiser could program a virtual tree to display various product icons. Although those icons might or might not be useful in the overall game, they could be made useful to further interaction with the tree, or some other features elsewhere in the landscape provided by the advertising broker, or to some reward provided outside the game. The players of the games created by independent developers, would be induced thereby to pay attention to, and even examine in detail, the features the advertiser wanted to publicize.

A developer of embedded advertisements to be distributed to other game developers could develop an Application Program Interface (API) or Software Development Kit (SDK) or software development framework which could provide many advantages. For example, such software tools could help third-party (independent) game developers to add subsidized landscapes, characters, or other features to their games. In this sense, “third-party” means a developer not employed by the tool creator, nor the developer of the game content being distributed. “Not employed by” would mean, in the case of a corporation or other entity that is not an individual person, “not owned by, nor a part of, nor under the control of”. Thus the tools would facilitate the placing of a given embedded advertisement in many games produced and distributed by many different, independent people and companies. Such wide distribution of advertisements will make feasible the crafting of more interesting and interactive advertising embedded in games.

Such software tools could also provide interactivity to the distributed game-features. Some useful interactive features that such tools could provide would include the ability for players of a third-party game to collect and manipulate product likenesses, converse with, touch, or otherwise interact with characters added by the advertiser, and receive information such as URLs, coupons, and product brochures in a form manipulable and storable by the player's computer. In this use, the software tools technically support the operation of some given game-feature containing embedded advertising inside various different games. Each of those games may have been created with its own software tools including Application Programming Interfaces, software frameworks, and Software Development Kits specific to the hardware the game runs on. The software tools described here for possible distribution as part of my invention, would provide common interface and adaptation to each of those game-specific sets of software tools. The typical purpose would be to allow an embedder of advertising to create a single software source module, containing both game content and embedded advertising, that would be able to operate inside each of several different third-party games.

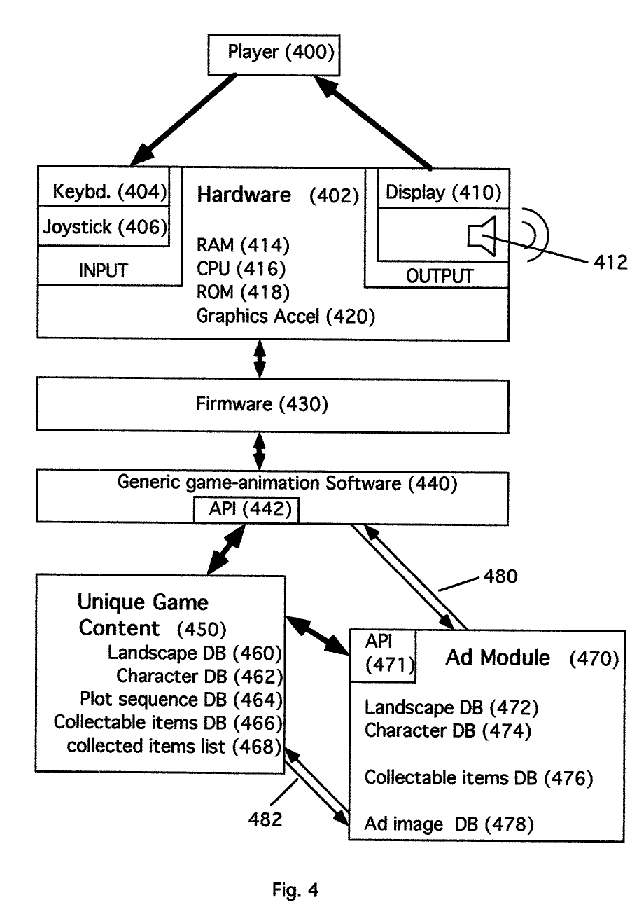

### FIG. 4—An Additional Embodiment—Embedding With Third-parties

FIG. 4 shows information flow between various modules comprising a traditional electronic game, plus an new module which adds embedded advertising from an advertising broker. Player 400 interacts with hardware 402 on which the game is played. Hardware 402 comprises many subparts including input hardware such as keyboard 404 and joystick 406. Hardware 402 also comprises subparts to output information to the human player 400, including graphic display 410 and speaker 412.

Besides the IO subparts described above, Hardware 402 comprises many computational subparts including Random Access Memory (RAM) 414, Central Processing Unit (CPU) 416, Read Only Memory (ROM) 418, and graphics acceleration circuitry 420. Firmware 430, stored inside ROM 418, helps run the game, or at least helps load additional software. Generic game animation software 440 provides much functionality for all the games that run on hardware 420. Some of the generic game software 440 may be created and/or distributed by the maker of game hardware 402. Some of the generic game software 440 may be created and/or distributed by independent parties. Software Development Kits (SDKs) and frameworks typically facilitate use of and access to the generic game software 440.

A small portion of generic game software 440 is an Application Programming Interface through which programmers control the generic game software 440 and, more indirectly, the underlying hardware 402. APIs typically consist of functions which can be invoked by programs. Game programmers write their programs to pass information to those API functions and to receive back information from them.

All the qualities that comprise an electronic game and make it different from any other game are defined by unique game content 450. In FIG. 4, unique game content 450 comprises several subparts, including a landscape database 460 which provides information about the geography, buildings, and other virtually inanimate features that players see as they wander through the virtual game areas.

Another subpart of game content 450 is character database 462 which supplies information about virtual people, characters, and other virtually animated features of the game. Typically there are many fewer animated game features than inanimate ones. However the animated ones have behavior as well as position, color, and shape. Behaviors can be very complex, so character database 462 can be large, too.

Another subpart of game content 450 is plot-sequence database 462 which describes which activities can be performed in which order. Like a novel, there is a plot to typical electronic games. However, unlike a novel, the order in which events occur is not rigidly fixed; players can choose to do many things in whatever order they want. However, to provide some structure to and progress during the game, there must generally be restrictions on when players can do certain things. Sequence database 462 can also influence when the game does unexpected or predictable things to the players' characters.

Another subpart of game content 450 is collectible item database 466 which supplies information about virtual objects that players can acquire as they progress through the game. Collected items list 468 remembers which items are possessed by the player.

Advertising module 470 imbues the system in FIG. 4 with the ability to present advertisements to players. Encapsulation of the advertising into a separate module should be done in a way that requires minimal programming on the part of the programmers and other developers of unique game content 450. Minimizing the burden on independent game developers is an economic boon for distributing an advertisement widely among different games.

Advertising module 470 comprises several subparts. Several of its subparts are structured and function much like those of the main part of the game, unique game content 450, including: landscape database 472, character database 474, and collectible items database 476. Those subparts supply advertising module 470 with information about geographies and inanimate items; people, animals, characters and other animatible items; and collectible items, respectively.

Advertising module 470 lacks a plot sequence database because the advertisers decided not to limit the player's interactions with their advertising. Advertising module 470 lacks a collected items list because it can effectively use that of the main game module, unique game content 450. Other embodiments of advertising modules of course could include such subparts; they are not generally necessary, however.

Advertising module 470 also contains subparts not included in the main part of the game, unique game content 450, including Application Programming Interface (API) 442, and advertised image database 478.

### Operation of Advertising Module FIG. 4

When a player, via his game-character, wanders into a game area supplied by advertising module 470, unique game content 450 calls a function in API 471 to get a reference to a data structure that describes the new landscape. Unique game content 450 passes that data reference to generic game-animation software 440, via its API 442. Generic game-animation software 440, calls back to advertising module 470 to extract data from the data structure. Callback information flow 480 provides details needed by generic game-animation software 440 to render images of the new landscape on the graphic display 410 via firmware and hardware.

As the player continues wandering though the new landscape supplied by advertising module 470, many more callbacks are made to advertising module 470 by generic game-animation software 440. Perhaps even thousands of such callbacks are made each second as the player's character wanders through the landscape supplied by advertising module 470. Note that the programmers and developers of unique game content 450 did not need to write additional lines of software code to handle each of those thousands of callbacks; they were handled for them because they used small, standardized API 471 created for them by the developers of advertising module 470. Thus the developers of unique game content 450 are inclined to use advertising modules such as advertising module 470 because its structure and function allows it to supply large amounts of interesting game features with little additional work on the part of the game developers.

Eventually the player encounters an advertised image that appears in the new landscape. That image is described in advertised image database 478. Advertised image database 478 can link the image with animatible characters, collectible items, or other desirable features. Information on those features can come from appropriate databases inside advertising module 470, including character database 474 and collectible items database 476.

The player can collect and retain items listed in collectible items database 476. When he collects an item supplied by advertising module 470, a reference to it is added inside collected items list 468. When the player exits the landscape supplied by advertising module 470, the reference to item he collected there is still retained by collected items list 468. When he then later examines it, unique game content 450 calls back to advertising module 470 along callback path 482. That callback path supplies whatever details are needed about the item. Thus the advertised product likenesses and other advertised images can continue to exist in the main game, outside the landscape supplied by advertising module 470. Again, the main game's developers are not burdened by this feature; advertising module 470, has been designed to do the hard work for them.

Items collected by players from advertising module 470, could include rewards useful either inside the game, or outside the game, such as coupons for products and admission rights to things outside the realm of the game. Thus players would be motivated to buy games with such embedded advertising. Therefore game developers would be motivated to include it.

It is also possible that characters supplied by advertising module 470, could wander into the main game's landscape and play areas. API 471 could be could include additional callback paths (not shown) to facilitate such spontaneous export of characters. Thus the main game would become enriched with several different kinds of additional game features. Simultaneously, the distributors of advertising module 470, would have several ways of advertising products and images.

API 471 includes a static member function of a base class of all embeddable, distributable, software advertising modules that allows new or additional embeddable, distributable, software advertising modules to be dynamically loaded while the game is being played. This is exploited by the advertising broker to send advertising modules across a network from central host computer 502 (in FIG. 5) to the game 500 (also in FIG. 5) which the player is playing. Those new, additional advertising modules contain advertisements targeted to appeal to the player. That selection of target audience could be made at the level of an identifiable individual, or could merely assure that specific embedded advertisements reach categories of players likely to respond favorably to the downloaded advertisements.

With the addition of appropriate APIs and callbacks (not shown), an advertising module could require players to interact with its advertisements in order for them to succeed in the game in which the module is embedded. Various advertising modules could be distributed via a communications network. Such remote distribution would facilitate widespread adoption of a given module and could allow tayloring or selection of advertising modules for specific players or groups of players.

### Advantages of Integrating Advertising Brokerage Services

My invention describes methods of distribution of completed or partially completed game content. Those distribution methods can augment embedded advertising features in inducing customers to visit advertisers' stores and businesses.

The invention also describes practices of grouping advertisements for different products, unrelated to each other, inside games. That technique will make the virtual advertising inside the games more economical. The developer will be able to amortize development expenses over more advertisers. The creation of games which function as general-purpose advertising venues will facilitate such economies. As games become popular for general-purpose advertising, thousands or millions of products or services could be advertised inside any one or many of them.

My invention also describes an advertising brokerage technique of offering one advertiser the right to place its advertisements in several different games. That will provide greater coverage for the advertiser trying to reach the largest number of consumers. This practice will also help the creators of advergames to maximize their profits. Being able to place embedded advertising in any of several, many, or thousands of resultant games also allows the development costs of complex embedded advertising features to be amortized over several or many different games.

### Conclusions, Ramifications, and Scope

My invention optimizes a recently created entertainment medium for carrying advertisements of products and services. The invention describes ways of drawing peoples' interest and continued attention to likenesses of advertisers' products and corporate and brand symbols and other advertisable property, tangible or intangible. By doing so, the invention imbues electronic games with great advantages over other media for carrying advertisements.

The great number of people who play electronic games constitutes a potential viewing audience for advertisements. Viewers' primary intent will be to do what is necessary to play the game successfully. The embedding techniques described in this invention can assure that virtual but conscious interaction with product and brand displays are key ingredients for success playing games utilizing this invention. This invention describes ways in which advertisers can assure that the impressions created by their advertisements are positive in the viewer's conscious mind and emotional associations.

This invention describes methods of displaying a product's features in a single game. My invention also increases the scope of that display to placing it in many different games, benefiting the advertiser, game developers, advertising broker, and player. Furthermore the invention describes how the creation of general-purpose advergames, and the practice of offering virtual advertising space in many games, facilitates economies of scale for creating games, game features, and embedded advertising features.

Although the description above contains many specificities, these should not be construed as limiting the scope of my invention, but as merely providing illustrations of some of the presently preferred embodiments of this invention.

For example, the physical distribution of electronic games bearing embedded advertising could be via electronic or optical transmission, magnetic surfaces or bulk solids, cartridges containing data-storing semiconductors or other electronics, or any other means of carrying information. The computational and display facilities could be provided by consoles dedicated to game-play, or by general-purpose computers. The games could be played in the players homes, or at businesses either associated or not with the advertisers. “Computer games” and “video games” are specifically included in my phrase “electronic games”; other animated games might be functionally equivalent and included also. The necessity for a conveniently short phrase to describe the relevant games should not limit the applicability of this patent.

The advertisers mentioned could be the same entities that publish or develop the games in which the advertisements are embedded. The publisher and developer of a game might or might not be part of the same economic entity. I have written this application with phrasing that describes techniques which require development action, but which could be planned and mandated by the publisher. In such cases my phrases often are written mentioning only the publishing or producing, but which need to be construed as including the development.

My use of the word “product” can include service, brand, line of products, data or economically valuable information. My use of the phrase “advertisable property” includes products (defined broadly as above), corporate logos, and images associated with brands. Candidates, candidacies, and propositions under debate or put forward for election or referendum, should also be included in “advertisable property” for brevity's sake, and also should be understood to have advertisable images. Advertisable property includes images and depictable items, groups, or activities; whether legally protected, such as by trademark, salesmark, or copyright; or not protected. My phrase “advertised image” can include or be of any of the things mentioned above in this paragraph.

My phrase “game feature” can include a landscape, building, vehicle, character, image, activity, level of play which might have a particular difficulty, virtual area or geography of play, passageway or portal, reward, clue, challenge, or coupon, right, or link to something outside the game. However the phrase is not limited to these categories.

Distribution can include sale, sale at a subsidized price, giving away for free, or paying other parties to take.

A place of business can be a real or virtual store, restaurant, factory, office, or information distribution point for physical items, data, games, software, persuasion, or information. It can be a web site or part of a site where business is transacted. It can also be any other place, real or virtual, where business of some sort is conducted. A virtual place can be the impression of a physical place or the presentation of functionality for distributing or making products (defined broadly as above) or otherwise conducting business. Often virtual places and things are electronically presented, frequently from a remote site using a communications network such as an internet.

A point of sale can include a store, market, restaurant or other place where products (defined broadly as above, but excluding candidates and propositions for elections, and things not legally sold) are sold to customers.

It may within the lifetime of this patent come to pass that equivalent animatible, interactive games can be provided by photonic or other techniques not not requiring traditional electronic components. Any such game should be considered the functional equivalent of what I call an “electronic game”.

Listing of credits for game development, content contribution, game development tool, game creation, or publishing should not be considered advertising as defined in this document.

Thus the scope of the invention should be determined by the appended claims and their legal equivalents, rather than by the examples given.

I claim:

1. An advertisement comprising an electronic game and an apparently three-dimensional likeness of an advertised product displayed in a manner noticeably different from the real product.

2. An advertisement of claim 1 wherein the product likeness is displayed at a reduced scale inside said game, whereby the product can be more conveniently represented in at least one place inside said game.

3. An advertisement of claim 1 wherein the product likeness is displayed at an oversized scale inside said game, whereby the player's impression of it is exaggerated or enhanced.

4. An advertisement of claim 1 wherein the likeness of a product becomes animated in a way impossible for that product in real life.

5. An advertisement comprising an electronic game and a collectible likeness of an advertised product displayed inside said game.

6. An advertising method comprising publishing an electronic game, and embedding within said electronic game, a three-dimensional likeness of an advertised product, and also embedding within said electronic game a likeness of a second, different kind of advertised product, not generally associated in real life with the activities the first said product is associated with.

7. An advertising method as in claim 6 wherein said second advertised product is sponsored by an entity different from that that sponsors said first advertised product.

8. A method of advertising comprising publishing an electronic game, and then later publishing an advertisement inside said game, from a sponsor that did not advertise in the originally published version of said game.

9. A method of advertising comprising publishing an electronic game, and publishing an advertisement inside said game for a sponsor, and publishing an advertisement for said sponsor in a different advertising venue.

10. A method of advertising as in claim 9 wherein at least one said publishing of said advertisement is to a venue that is not associated with an electronically disseminated depot of information dominated by that sponsor.

11. An advertisement comprising an electronic game, and a likeness of a place of business of the advertisement's sponsor, embedded within said game.

12. An advertisement as in claim 11 wherein said place of business contains a reward for the player who visits said place of business.

13. An advertisement comprising an electronic game, and an advertised image embedded within said game and associated with a desirable feature.

14. An advertisement as in claim 13, wherein said desirable feature is a reward.

15. An advertisement comprising an electronic game, and an advertised image embedded in said game, and a means of rewarding a player for demonstrating knowledge in said game.

16. An advertisement as in claim 15 wherein said demonstrated knowledge is a fact concerning the advertisable property represented by said advertised image, whereby players are motivated to learn about said advertised product.

17. A method of advertising comprising the creating of game features, and the embedding of advertising in said game features, and the distributing of said game features with said embedded advertising to independent game producers.

18. A method of advertising comprising providing an electronic game, and embedding an advertised image within said game, and embedding a likeness of a celebrity also within said game and associated with the advertised property so that said celebrity enhances the advertisement.

19. A method of advertising as in claim 18 wherein said celebrity's likeness uses advertised property represented by said advertised image.

20. A method of advertising as in claim 18 wherein said celebrity's likeness mentions said advertised property.

21. A method of advertising as in claim 18 wherein said celebrity's likeness directs players toward advertised property.

22. A method of advertising comprising embedding an advertisement inside an electronic game, and publishing said game, and then later removing said advertisement.

23. A method of advertising as in claim 22, further including adding a new game feature in said game after removing said advertisement, and then publishing the new version of the game, whereby players are motivated to obtain and play the new version of the game which has said originally published advertisement removed.

24. An advertisement comprising an electronic game, and an inducement in the game to use a sponsor's software.

25. An advertisement as in claim 24, wherein said sponsor's software is a needed means for communication in conjunction with the game, to obtain a reward.

26. A method of advertising comprising embedding advertising for a sponsor in an electronic game, and distributing said game through a sponsor's place of business.

27. A method of advertising as in claim 26 wherein the said place of business is a point of sale.

28. A method of advertising as in claim 27 wherein the said point of sale is a physical point of sale, whereby players are motivated to visit said point of sale and once there have a convenient opportunity buy products.

29. A method of selling comprising publishing an electronic game, and embedding a means of transacting a purchase in said game.

30. A tool for advertising, comprising a software module that can exchange information with the unique game content of an independent game developer, and advertisements embedded inside said software module.

31. A tool for advertising as in claim 30 wherein said tool contains means for selectably being loaded for selected players.
